(19) United States
(12) Patent Application Publication
(10) Pub. No.: US 2022/0184439 A1
(43) Pub. Date: Jun. 16, 2022

(54) AUGMENTED REALITY MODEL-BASED FIRE EXTINGUISHER TRAINING PLATFORM

(71) Applicant: CARRIER CORPORATION, Palm Beach Gardens, FL (US)

(72) Inventors: May L. Corn, Manchester, CT (US); Vaidyanathan Sankaran, Ellington, CT (US); Peter R. Harris, West Hartford, CT (US); Zhen Jia, Shanghai (US); Changmin Cao, Shanghai (CN); Danqing Sha, Shanghai (CN); Craig R. Walker, South Glastonbury, CT (US); Hui Fang, Shanghai (CN)

(21) Appl. No.: 16/973,179

(22) PCT Filed: Jun. 5, 2020
(86) PCT No.: PCT/US2020/036345

§ 371 Date: Dec. 8, 2020

Related U.S. Application Data
(60) Provisional application No. 62/863,313, filed on Jun. 19, 2019.

(51) Int. Cl. A62C 99/00; G09B 19/00; G06F 3/0346; G06F 3/01

(52) U.S. Cl. CPC A62C 99/0081; G06F 3/011; G06F 3/0346; G09B 19/00

(57) ABSTRACT

Provided are embodiments including a system for operating an augmented reality model-based fire extinguisher training platform. The system includes a computation engine configured to receive one or more inputs and generate a simulation based on the one or more inputs, and a fire extinguisher configured to communicate with the computation engine, wherein the fire extinguisher includes a plurality of sensors to provide feedback to the computation engine. The system also includes a display device that is operably coupled to the computation engine and is configured to display the generated simulation from the computation engine, and wherein the computation engine is configured to perform analytics to generate a recommendation for a design of the fire extinguisher based at least in part on the feedback from fire extinguisher. Also provided are embodiments that include a method for operating an augmented reality model-based fire extinguisher training platform.

### CROSS REFERENCE TO RELATED APPLICATIONS

This application claims the benefit of U.S. Application No. 62/863,313, filed on Jun. 19, 2019, which is incorporated herein by reference in its entirety.

### BACKGROUND

The present disclosure relates generally to training platforms, and more specifically to an augmented reality model-based fire extinguisher training platform.

Many people, ranging from first-time users to certified fire-fighters, can benefit from training on the proper technique and management of fire extinguishers. Traditional training methods are provided by video and commentary providing an explanation on the proper techniques. In addition, some training materials can be provided by way of pamphlets and other documents to guide users through the training. Advanced training platforms can include using real fires and fire extinguishers in a controlled environment. However, the training in a controlled environment can become very costly and increases the safety risk to those trainees involved. There may be a need to efficiently train personnel to properly use various fire extinguishing devices in a range of scenarios.

### BRIEF SUMMARY

According to an embodiment, a system for operating an augmented reality model-based fire extinguisher training platform is provided. The systems includes a computation engine configured to receive one or more inputs and generate a simulation based on the one or more inputs, and a fire extinguisher configured to communicate with the computation engine, wherein the fire extinguisher includes a plurality of sensors to provide feedback to the computation engine. The system includes a display device that is operably coupled to the computation engine and is configured to display the generated simulation from the computation engine, wherein the display device is a wearable augmented reality headset, and wherein the computation engine is configured to perform analytics to generate a recommendation for a design of the fire extinguisher based at least in part on the feedback from fire extinguisher.

In addition to one or more of the features described herein, or as an alternative, further embodiments include a computation engine that generates the simulation using a graphics processing unit (GPU) based Lattice-Boltzmann Methods (LBM) solver that generates a high fidelity physics-based computational fluid dynamics (CFD) simulation of a fire in real-time.

In addition to one or more of the features described herein, or as an alternative, further embodiments include a camera that is configured to monitor a location of one or more users and a position and orientation of one or more corresponding fire extinguishers during the simulation, wherein video data from the camera is used to make the recommendation.

In addition to one or more of the features described herein, or as an alternative, further embodiments include at least one angle sensor coupled to a handle of the fire extinguisher to measure an engagement of the handle to discharge an agent during the simulation.

In addition to one or more of the features described herein, or as an alternative, further embodiments include at least one position sensor coupled to a cylinder of the fire extinguisher to determine a position and orientation of the fire extinguisher during the simulation.

In addition to one or more of the features described herein, or as an alternative, further embodiments include using one or more inputs such as a fire type, fire size, fire extinguisher type and extinguisher size.

In addition to one or more of the features described herein, or as an alternative, further embodiments include using a fire type that includes a fuel source of the simulated fire comprising at least one of paper source, a wood source, a liquid fuel source, a electrical source, and a metal source.

In addition to one or more of the features described herein, or as an alternative, further embodiments include using an extinguisher type that includes a powder type, liquid type, and gas type extinguisher.

In addition to one or more of the features described herein, or as an alternative, further embodiments include providing a recommendation for a feature modification to the fire extinguisher based at least in part on aggregated feedback data from multiple users of the fire extinguisher.

In addition to one or more of the features described herein, or as an alternative, further embodiments include using feature modifications that include at least one of a handle position of the fire extinguisher or a flow rate of the agent of the fire extinguisher.

According to another embodiment, a method for operating an augmented reality model-based fire extinguisher training platform is provided. The method includes receiving one or more inputs to generate a simulation, modeling a simulation based on the one or more inputs, presenting the simulation to a display device, and adapting the simulation in real-time according to inputs from a fire extinguisher and the simulation. The method also includes monitoring feedback of a fire extinguisher during the simulation, and recommending updates for the fire extinguisher based at least in part on the monitored feedback.

In addition to one or more of the features described herein, or as an alternative, further embodiments include a display device that is a wearable augmented reality display device which presents a simulated fire.

In addition to one or more of the features described herein, or as an alternative, further embodiments include using feedback from the fire extinguisher includes a flow rate of an agent and direction the agent of the fire extinguisher is provided to a simulated fire.

In addition to one or more of the features described herein, or as an alternative, further embodiments include using one or more inputs that include afire type, fire size, extinguisher type, and extinguisher size.

In addition to one or more of the features described herein, or as an alternative, further embodiments include using a fire type that includes at least one of a paper source, a wood source, a liquid fuel source, an electrical source, and a metal source.

In addition to one or more of the features described herein, or as an alternative, further embodiments include using an extinguisher type that includes a powder type, liquid type, and gas type extinguisher.

In addition to one or more of the features described herein, or as an alternative, further embodiments include providing feature modifications to the fire extinguisher based at least in part on aggregated feedback data from multiple users.

In addition to one or more of the features described herein, or as an alternative, further embodiments include feature modifications that include at least one of a handle position of the fire extinguisher or a flow rate of the agent of the fire extinguisher.

According to a different embodiment, a fire extinguisher used in an augmented reality model-based fire extinguisher training platform is provided. The fire extinguisher includes a cylinder of the fire extinguisher, and a position sensor coupled to the cylinder, wherein the position sensor is configured to determine a position and orientation of the cylinder during a simulation. The fire extinguisher can also include an angle sensor coupled to a handle of the fire extinguisher, wherein the angle sensor is configured to determine a position of the handle corresponding to a flow rate of an agent of the cylinder, and a communication interface that is configured to communicate with a computation engine used to generate a real-time simulation of a fire.

In addition to one or more of the features described herein, or as an alternative, further embodiments include a computation engine that is configured to generate the simulation using a graphics processing unit (GPU) based Lattice-Boltzmann Methods (LBM) solver that generates a high fidelity physics-based computational fluid dynamics (CFD) simulation of the agent injection from the fire extinguisher and its application to and suppression of a fire in real-time.

Technical effects of embodiments of the present disclosure include providing a realistic user experience based on computational fluid dynamics (CFD) models across a wide range of fire types and extinguisher types. This allows the system to obtain a more realistic feedback experienced by the user to elicit a more credible reaction to the fire-fighting experience. The resulting data collected and processed by the system provides accurate data to improve future fire extinguisher designs and training techniques.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 depicts an illustration of a system for operating an augmented reality model-based fire extinguisher training platform in accordance with one or more embodiments:

FIG. 2 depicts an extinguisher used in an augmented reality model-based fire extinguisher training platform in accordance with one or more embodiments; and

FIG. 3 depicts a method for operating an augmented reality model-based fire extinguisher training platform in accordance with one or more embodiments.

### DETAILED DESCRIPTION

Various types of fire extinguisher training platforms are used for training individuals on the proper use of fire extinguishers and techniques to fight fires in a range of scenarios. Existing simulators vary in sophistication, and some existing simulators use game-based platform models to train users. However, these models are limited and do not have the capability to correctly model different fire sources or fire extinguisher agents. That is, during the game-based simulation a generic, common, or same fire source is used when training across a range of scenarios. For example, game-based platforms do not provide dynamic models that are used during the simulations and the game-based platforms also do not record feedback 112 from the user device (the extinguisher) during the simulation. In addition, setting up the controlled environments for the different types of fires and conditions can become a costly and risky endeavor when training users on the different scenarios.

The techniques that are provided herein allow for realistic fire interactions for users which can be used in a training platform. By using a simulated environment the users that are being trained and training staff are safer when compared to generating an actual fire. In addition, the pollution emitted into the atmosphere is reduced and the costs can be vastly reduced.

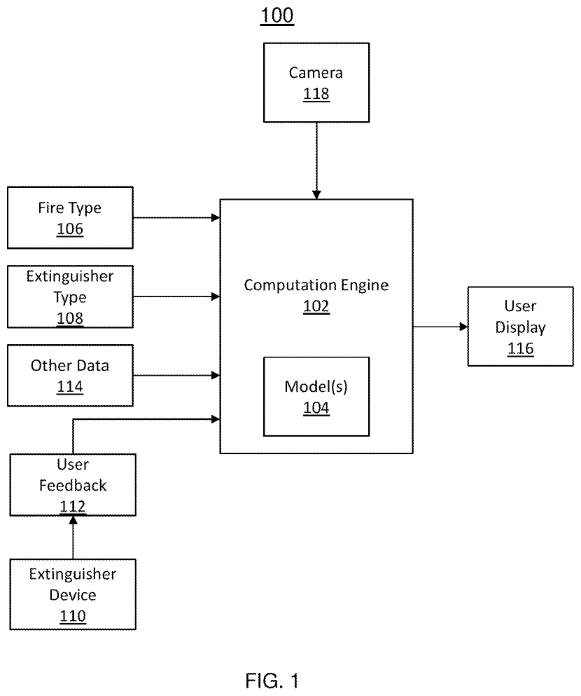

FIG. 1 depicts a system 100 for operating an augmented reality model-based fire extinguisher training platform in accordance with one or more embodiments. The system 100 includes a computation engine 102. The computation engine 102 can be included within a computing system, computing device, or server. The computation engine 102 can be local or remote to the training area where the simulation is executed.

The computation engine 102 is a graphics processing unit (GPU) based Lattice-Boltzmann Methods (LBM) solver that generates a high fidelity physics-based computational fluid dynamics (CFD) simulation of the fire in real-time. CFD is a discipline within fluid dynamics that uses numerical analysis and data structures to model fluid flow. CFD can be used in a range of applications including but not limited to aerodynamics, weather simulation, fluid flows generally, etc. The types of fluid, boundaries, and other factors are input into the model to simulate a depiction of the fluid flow. The model 104 requires one or more inputs including a fire type, extinguisher type, environmental conditions, and user feedback 112 captured by sensors on the instrumented fire extinguisher and augmented reality (AR) system cameras. The computation engine 102 is configured to provide a dynamic real-time simulation of fires that are fueled by various sources and how the fires respond to the application of various agents by the fire extinguisher. The computation engine 102 is configured to perform analytics that uses data from a plurality of users to identify design features for future improvement (e.g., in ergonomics, in improving the discharge of flow) based on the feedback 112 obtained during one or more simulations. For example, the position of the fire extinguisher can be monitored to ensure it is held in the correct position to allow the suppressant to efficiently flow from the fire extinguisher. If the fire extinguisher is held in the wrong position the suppressant may not be allowed to flow out of the fire extinguisher as it was designed. A recommendation can be made responsive to analyzing a number of users and a how they are using the fire extinguishers and a recommendation for an ergonomic modification of the fire extinguisher such as but not limited to changing the position of the fire extinguisher handle or changing the type of handle to make it more suitable for the user to hold the fire extinguisher in the correct position. It should be understood that the modifications can be based at least in part on the type of fire extinguisher or other factors. Also, as previously described above the flow rate of the suppressant that is discharged from the fire extinguisher can be optimized based on assessing the current flow rate and how the fire responds at the current rate. It should be understood that the flow rate can be increased or decreased. It should also be understood that the coverage of the nozzle can also be adjusted to obtain the optimal coverage for a given flow rate. For example, a large coverage area that is not supported by the flow rate, suppressant type, extinguisher design, etc. may not provide desirable results when discharging the suppressant. In addition, the computation engine 102 is configured to assess the impact on the user of different internal design changes (intended changes and unintended changes resulting from product aging and degradation) using the augmented reality trainer. For example, the computation engine 102 can collect data after updates have been made to the fire extinguisher and the performance of the fire extinguisher can be compared to determine if the desired performance is achieved. In addition, the product aging and degradation can be modeled by the computation engine 102 to simulate the performance of a fire extinguisher that may not have been used for a period of time.

The fire type 106 can also be input into the computation engine 102. In one or more embodiments, the fire type 106 can indicate the source of the fire such as paper, wood, liquid fuels, electrical, metals, etc. Fires that are started from various sources can propagate differently and generate different types and amounts of smoke particles that affect visibility. In addition, another input for the computation engine can include the size of the fire. The size of the fire can also impact the behavior of the fire. The simulation can include fires that exist in a waste basket or a room or a building or any other type of environment.

In one or more embodiments, the extinguisher type 108 and size is input into the system. The extinguisher type 108 can include the agent used as the suppressant such as a powder type suppressant, liquid type suppressant, gas type suppressants, etc. For example, the extinguisher size can range from personal fire extinguishers for home use or larger fire extinguishers for large areas or commercial use. This allows the training simulator to train people on different types of fire extinguishers and agents. These different agents have different properties and will impact the how the fire responds to the various agents, including the amount of smoke generated by the suppression process.

These inputs allow the computation engine 102 to generate models for different types of fires and extinguishers used during the simulation. This is important because all fires do not behave the same or respond the same to stimulants and/or agents provided to the fire.

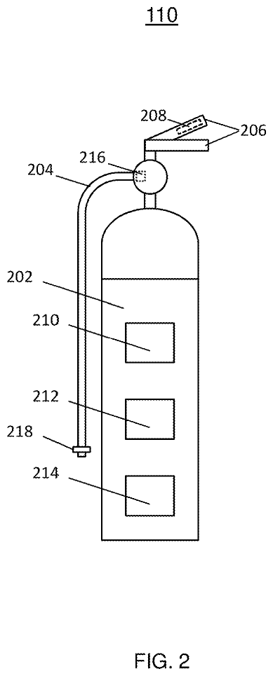

The system 100 also includes a fire extinguisher 110 that is used during the simulation. The components of the fire extinguisher 110 are discussed in further detail with reference to FIG. 2. The fire extinguisher 110 can be provided in a variety of sizes and weights to provide a real-life experience during the simulation. In addition, changes in the internal component design can be specified which can affect the flow output from the fire extinguisher 110. Data can be collected during the simulation to assess how the design change affects the user's discharge of the fire extinguisher 110. During the simulation, the fire extinguisher 110 can be configured to simulate an extinguisher of various agent types. The computation engine 102 receives the feedback information 112 from the fire extinguisher 110 and processes the information. The feedback information 112 can include the manner in which the user holds the fire extinguisher and the nozzle (if the fire extinguisher model includes a hose attachment) and engages the handle or trigger of the fire extinguisher 110 to release the agent. It should be understood that other feedback 112 can be obtained by the fire extinguisher 110 and provided to the computation engine 102.

Also, other data 114 can be input into the system 100 such as environmental conditions to generate a model 104 to simulate the behavior of the fire according to those conditions. For example, a dry and hot environment can be used generate a model or a wet and humid environment can be used. In another example, windy conditions can be simulated by the computation engine 102. Other environmental conditions can be input into and modeled by the system 100.

The user display 116 shown in the system 100 can include a wearable headset that provides an augmented reality display for a user. The wearable headset can provide an image in the lenses of the wearable headset that is overlaid on the actual view of the environment. That is, this technology superimposes a computer-generated image on the user's view of the real world, thus providing a combined view of the simulated fire and smoke over the actual environment. The wearable headset can also provide data on what the user is currently viewing to the computation engine 102. In other embodiments, the computation engine 102 can provide the data to a display device of another computing device to display the obtained data from the simulation. In addition, the display can include the current conditions of the simulation such as the fuel source, fire size, smoke color and density, extinguisher size, extinguisher type, environmental conditions, etc. The information that is displayed is not limited by that listed above but only provides an illustrative example.

In one or more embodiments, the computation engine 102 is configured to provide suggestions to the display device of the user 116 during the simulation to improve their performance during the simulation. This provides an additional training tool to train users on the different types of fires using different types of extinguishers.

The image and video capturing device or camera 118 is configured to capture video data of the simulation area. The camera is configured to detect the location of the nozzle of the fire extinguisher and the people. By collecting video of the users and the nozzle of the fire extinguisher, the computation engine 102 can analyze the technique of the user to extinguish the fire. In addition, the video data can be used to analyze and/or confirm the orientation in which the fire extinguisher is held. For example, the user's comfort and hand placement can be analyzed and used to make further recommendations on design improvements including but not limited to handle types, handle placement, etc. The data collected by the position sensor can also be verified by comparing the data from the position sensor to the video data collected by the one or more cameras during the simulation.

In addition, multiple users can participate in a single simulation, where the camera 118 is configured to track the plurality of users and their corresponding fire extinguishers. The feedback 112 that is obtained from each of the users in the simulation or across a number of simulations can be used to generate recommendations for designing fire extinguishers. For example, an average position or orientation the fire extinguisher can be determined for a plurality of users which can be used to provide a recommendation to modify the fire extinguisher handle so the fire extinguisher will naturally be positioned in an optimal position. In another example, the flow rate of the fire extinguisher can be modified based on the measured impact to the simulated fire over a number of simulations to achieve a desired result. It should be understood that the computation engine 102 can obtain data and provide other types of recommendations in the design of the fire extinguisher and is not limited by the described herein.

In one or more embodiments, the simulation can be coordinated with heat generating equipment and audio equipment to simulate the heat and noise produced in various types of fires to simulate a real-time environment and true-to-life response from the user.

In one or more embodiments, the computing engine 102 can be located inside the fire extinguisher 110 and is in communication (wired or wireless) with a handheld device such as a mobile device or table, for example.

Now referring to FIG. 2, a fire extinguisher 110 that is used during the simulation is shown. The fire extinguisher 110 includes a cylinder 202, a hose 204, and a handle 206. The fire extinguisher 110 can be designed to provide an experience of an actual fire extinguisher 110 used in a real-life scenario. The fire extinguisher 110 includes a plurality of sensors to obtain user feedback 112. For example, one sensor can include an angle sensor 208 and a force sensor that is coupled to the first extinguisher handle 206. The angle measured by the angle sensor 208 can be correlated to the valve displacement, which affects the agent mass discharge rate. The same sensor unit can monitor the amount of force the user is applying to the fire extinguisher handle 206. This can be an indication of that the user is fully engaging the fire extinguisher handle 206 or is partially engaging the fire extinguisher handle 206. In addition, this can also indicate whether a user is intermittently engaging and disengaging the fire extinguisher handle 206 which can lead to a failure of the operation of the extinguisher. The angle sensor is configured to communicate with the computation engine 102 which can receive and analyze the input. In a scenario where the fire extinguisher 110 does not include a hose 204, a sensor 216 can be positioned at the nozzle outlet to monitor the velocity and coverage of the nozzle as the user sweeps the fire extinguisher 110 back and forth. In another scenario, a fire extinguisher 110 having a hose 204 can include a sensor 218 which can be used to track the motion of the hose 204 during the simulation as a user sweeps the hose 204 back and forth.

In FIG. 2, the fire extinguisher 110 also includes a position sensor 210 to monitor the cylinder 202 position, angle, and orientation. The position sensor 210 can include a gyroscope or accelerometer to monitor the orientation of the fire extinguisher 110. Another position sensor 216 is used to determine a direction in which nozzle is spraying the suppressant or the position sensor 218 is used to determine a direction in which the hose 204 (if equipped) is spraying the suppressant. The position sensor 210 can be used determine the orientation of the extinguisher, which affects the internal flow of the agent before it exits the valve. In an example, when a user holds the cylinder upside-down, the position sensor 210 will detect this position and orientation, and the agent, such as a powdered agent, may not flow out effectively during the simulation. It is to be understood that other sensors 212 can be coupled to the fire extinguisher 110 to obtain additional information related to a user's performance during the simulation.

The fire extinguisher 110 also includes a communication interface 214 to communicate with one or more components and/or systems. The communication interface 214 can communicate with the computation engine 102 using a wired or wireless connection and provides data from the sensors and other components of the fire extinguisher 110.

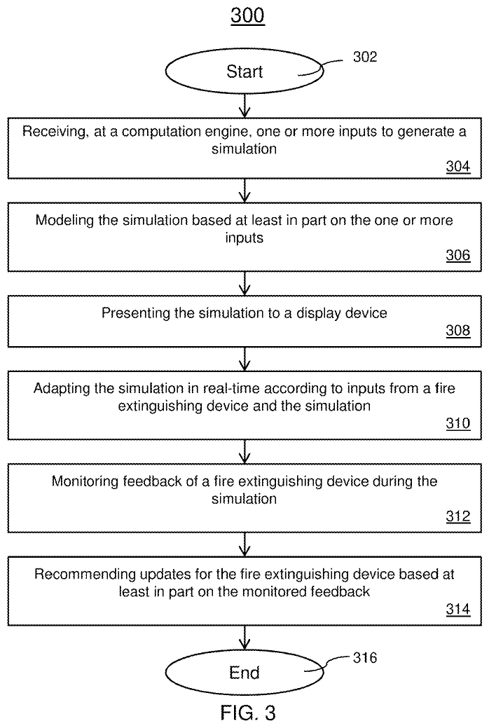

FIG. 3 depicts a flowchart of a method 300 for operating an augmented reality mode-based fire extinguisher training platform in accordance with one or more embodiments. The method 300 can be implemented in the system 100 of FIG. 1. The method 300 begins at block 302 and proceeds to block 304 which provides for receiving one or more inputs to generate a simulation. The computation engine 102 is configured to receive several inputs such as the fire type, extinguisher type, etc. to generate a model for a simulation. At block 306, the computation engine 102 models a simulation based on the one or more inputs. In one or more embodiments, the computation engine 102 uses a GPU based LBM solver to generate high fidelity physics-based CFD solutions in real-time.

At block 308 the computation engine presents the simulation to a display device. In one or more embodiments, a wearable display is provided so that a user can interface with the simulated fire. This allows the user to aim the fire extinguisher and engage the trigger to engage the fire extinguisher based on the visual display presenting the simulated fire. The method 300 at block 310 provides for adapting the simulation in real-time according to inputs from a fire extinguisher and the simulation. Responsive to the input from the fire extinguisher such as engaging the handle to release the agent and the direction and orientation of the fire extinguisher and the nozzle, the simulation is updated to reflect the flow of the agent out of the extinguisher, the application of the agent and its subsequent effect on suppressing the fire. The simulation is dynamic, unlike the game based platforms, and responds to the time and direction when the fire extinguisher is engaged.

At block 312 the method 300 provides for monitoring feedback 112 of a fire extinguisher during the simulation. The computation engine 102 is configured to communicate with the fire extinguisher and monitor the position and orientation of the fire extinguisher and the duration that the handle is pressed. In one or more embodiments of the invention, the simulation adjusts the size of the fire and the amount of smoke responsive to the application of the agent which is provided as feedback 112 to the computation engine 102 wherein the application of the agent can be detected by the angle sensor. Block 314 provides for recommending updates for the fire extinguisher based at least in part on the monitored feedback 112. The monitored feedback 112 can include but is not limited to the position and orientation of the fire extinguisher, the engagement of the fire extinguisher handle, the movement of the fire extinguisher and nozzle during use, the discharge rate of the suppressant, etc. Using the monitored data, the computation engine 102 can provide recommendations on ergonomic modifications and optimal flow rates for the fire extinguisher. The computation engine 102 can obtain feedback 112 from a user or aggregate the feedback 112 from a number of users to determine whether a recommendation to make ergonomic modifications or adjust the flow rate should be provided. In a non-limiting example, if a threshold number of users are not using the fire extinguisher at the designed position to allow for efficient suppressant discharge, a recommendation can be provided. The recommendation can include data regarding an adjustment to the fire extinguisher handle to achieve the desired fire extinguisher orientation. The computation engine 102 can also analyze the feedback 112 over a configurable period of time. The method 300 ends at block 316. It should be understood that the techniques described herein are not limited by the steps provided in FIG. 3 but other steps or different steps can be used.

The technical effects and benefits provide a more realistic user experience based on CFD models instead of game-based models, across a wide range of fire types and extinguisher types. The realistic feedback experienced by the user elicits a more credible reaction to the fire-fighting experience, and the resulting data that are collected and processed by this system will thus provide more accurate data to improve future fire extinguisher designs and training techniques.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A system for operating an augmented reality model-based fire extinguisher training platform, the system comprising:
a computation engine configured to receive one or more inputs and generate a simulation based on the one or more inputs;
a fire extinguisher configured to communicate with the computation engine, wherein the fire extinguisher includes a plurality of sensors to provide feedback to the computation engine; and
a display device that is operably coupled to the computation engine and is configured to display the generated simulation from the computation engine, wherein the display device is a wearable augmented reality headset;
wherein the computation engine is configured to perform analytics to generate a recommendation for a design of the fire extinguisher based at least in part on the feedback from fire extinguisher.

2. The system of claim 1, wherein the computation engine generates the simulation using a graphics processing unit (GPU) based Lattice-Boltzmann Methods (LBM) solver that generates a high fidelity physics-based computational fluid dynamics (CFD) simulation of a fire in real-time.

3. The system of claim 1, further comprising a camera that is configured to monitor a location of one or more users and a position and orientation of one or more corresponding fire extinguishers during the simulation, wherein video data from the camera is used to make the recommendation.

4. The system of claim 1, wherein the plurality of sensors include at least one angle sensor coupled to a handle of the fire extinguisher to measure an engagement of the handle to discharge an agent during the simulation.

5. The system of claim 1, wherein the plurality of sensors include at least one position sensor coupled to a cylinder or nozzle of the fire extinguisher to determine a position and orientation of the fire extinguisher during the simulation.

6. The system of claim 1, wherein one or more inputs include a fire type, fire size, fire extinguisher type and extinguisher size.

7. The system of claim 6, wherein the fire type includes a fuel source of the simulated fire comprising at least one of paper source, a wood source, a liquid fuel source, a electrical source, and a metal source.

8. The system of claim 6, wherein the extinguisher type includes a powder type, liquid type, and gas type extinguisher.

9. The system of claim 1, wherein the recommendation provides a feature modification to the fire extinguisher based at least in part on aggregated feedback data from multiple users of the fire extinguisher.

10. The system of claim 9, wherein the feature modifications includes at least one of a handle position of the fire extinguisher or a flow rate of the agent of the fire extinguisher.

11. A method for operating an augmented reality model-based fire extinguisher training platform, the method comprising:
receiving one or more inputs to generate a simulation;
modeling a simulation based on the one or more inputs;
presenting the simulation to a display device;
adapting the simulation in real-time according to inputs from a fire extinguisher and the simulation;
monitoring feedback of a fire extinguisher during the simulation;
recommending updates for the fire extinguisher based at least in part on the monitored feedback.

12. The method of claim 11, wherein the display device is a wearable augmented reality display device which presents a simulated fire.

13. The method of claim 11, wherein the feedback from the fire extinguisher includes a flow rate of an agent and direction the agent of the fire extinguisher is provided to a simulated fire.

14. The method of claim 11, wherein the one or more inputs includes a fire type, fire size, extinguisher type, and extinguisher size.

15. The method of claim 14, wherein the fire type includes at least one of a paper source, a wood source, a liquid fuel source, an electrical source, and a metal source.

16. The method of claim 14, wherein the extinguisher type includes a powder type, liquid type, and gas type extinguisher.

17. The method of claim 11, further comprising providing feature modifications to the fire extinguisher based at least in part on aggregated feedback data from multiple users.

18. The method of claim 17, wherein the feature modifications includes at least one of a handle position of the fire extinguisher or a flow rate of the agent of the fire extinguisher.

19. A fire extinguisher used in an augmented reality model-based fire extinguisher training platform, the fire extinguisher comprising:
a cylinder of the fire extinguisher;
a position sensor coupled to the cylinder, wherein the position sensor is configured to determine a position and orientation of the cylinder during a simulation; and
an angle sensor coupled to a handle of the fire extinguisher, wherein the angle sensor is configured to determine a position of the handle corresponding to a flow rate of an agent of the cylinder; and
a communication interface that is configured to communicate with a computation engine used to generate a real-time simulation of a fire.

20. The fire extinguisher of claim 19, wherein the computation engine is configured to generate the simulation using a graphics processing unit (GPU) based Lattice-Boltzmann Methods (LBM) solver that generates a high fidelity physics-based computational fluid dynamics (CFD) simulation of the agent injection from the fire extinguisher and its application to and suppression of a fire in real-time.
